(19) United States
(12) Patent Application Publication
(10) Pub. No.: US 2026/0189108 A1
(43) Pub. Date: Jul. 2, 2026

(54) ELECTRICAL MACHINE COMPRISING A TEMPERATURE SENSOR INTEGRATED INTO THE ROTOR

(71) Applicant: AMPERE S.A.S., Boulogne Billancourt (FR)

(72) Inventor: Emmanuel MOTTE, Cleon (FR)

(73) Assignee: AMPERE S.A.S., Boulogne Billancourt (FR)

(21) Appl. No.: 19/127,927

(22) PCT Filed: Oct. 20, 2023
(86) PCT No.: PCT/EP2023/079376

§ 371 Date: May 7, 2025

(30) Foreign Application Priority Data
Nov. 8, 2022 (FR) FR2211614

(51) Int. Cl. H02K 11/25; H02K 1/24

(52) U.S. Cl. CPC H02K 11/25; H02K 1/24

(57) ABSTRACT

An electrical machine includes a stator, a rotor with salient poles, a rotating shaft on which the rotor is mounted, and a temperature sensor. The temperature sensor is arranged between a rotor winding and a rotor body.

The present invention relates to the field of electrical engineering, and relates more specifically to an electric machine comprising a salient pole rotor.

In such an electric machine, the rotor comprises a winding around each of its salient poles. In applications requiring significant power from the electric machine, in particular when it is used in an electric or hybrid vehicle, it is necessary to monitor the temperature of the windings of the rotor, in order to prevent these windings from overheating, which could result in the insulating enamels of the wires of the windings being destroyed and produce short circuits at the rotor.

In order to avoid this situation occurring above a critical temperature threshold of the windings, electric machines in which the rotor is a salient pole rotor conventionally comprise a system for controlling the temperature of the windings, preventing this temperature from reaching this critical temperature threshold. In particular, in such a machine, a process for limiting the performance of the machine is implemented as soon as the temperature of the windings reaches a safety margin below this critical temperature threshold, which aims to leave time for the temperature of the windings to drop sufficiently far in advance, i.e. without leaving time for the windings to reach the critical temperature threshold on account of the latency of this performance limitation. For example, the motor torque of the electric machine is limited as soon as the temperature of the windings of the rotor is 10 degrees Celsius below the critical temperature threshold.

This safety margin is all the more important since it is difficult to precisely estimate the temperature of the windings of the rotor. As a result, the torque requested by the driver of an electric vehicle powered by such a machine is limited excessively rapidly as soon as the machine has provided a maximum power within the duration. The performance of the vehicle and the drivability are therefore directly impacted by the imprecision of the estimation of the temperature of the rotor.

Specifically, currently, the temperature of the rotor is often estimated on the basis of a thermal model using a temperature measurement taken at the stator, or on the basis of a model using, on the one hand, a rotor resistance calculated on the basis of measurements or estimations of currents, speeds and stator or rotor fluxes and, on the other hand, a reference resistance measured during tests carried out at the end of the production line of the rotor, such as in document FR3033961, for example.

However, by using values measured or estimated at the end of the production line, such as thermal resistances or a reference resistance, these processes provide an estimation of the temperature of the rotor that deviates over time with respect to the actual temperature of the rotor, or with respect to the temperature of a machine having manufacturing defects. Specifically, for example, between a reference machine and a machine having hot crimping that is defective or has worsened over time, or having a turn that has been cut, these resistances are different. These differences between the estimation of the temperature of the rotor and the actual temperature of the rotor explain the application, in the implementation of the performance limitations of the electric machine, of a safety margin that is greater than the margin that would be necessary with real-time measurement of the temperature of the rotor.

The present invention at least partially overcomes the drawbacks of the prior art by providing an electric machine, the temperature of the rotor of which is measured directly on the rotor.

To this end, the invention proposes an electric machine comprising a stator, a salient pole rotor, a rotating shaft on which the rotor is mounted, and a temperature sensor, the electric machine being characterized in that the temperature sensor is arranged between a winding of the rotor and a body of the rotor.

Directly arranging a temperature sensor on the rotor rather than on the stator makes it possible to reduce the safety margin applied with respect to a critical temperature threshold of the rotor requiring a limitation of the performance of the machine. This arrangement between the winding of the rotor and the body of the rotor makes it possible to precisely measure the temperature of the windings, which would not be possible by positioning the temperature sensor in free spaces of the rotor, such as between the winding wedges and the body of the rotor, for example.

In one embodiment of the invention, the temperature sensor comprises a thermistor. This type of temperature sensor has the advantage of being very precise and economical. It is, for example, an NTC (negative temperature coefficient) or PTC (positive temperature coefficient) temperature sensor.

According to one advantageous feature of the electric machine according to the invention, the body of the rotor comprises a central part and a plurality of teeth distributed angularly around the central part, at least one tooth extending parallel to the axis of the rotating shaft from a first axial end of the body to a second axial end of the body, and extending radially from the central part to a pole head, the electric machine further comprising at least one winding overhang guide that is adjoined on the first or the second axial end of the body and comprising at least one branch arranged on an axial end of the tooth, the winding of the rotor surrounding the tooth and the branch of the winding overhang guide, the temperature sensor being housed in the branch of the winding overhang guide.

The various teeth of the rotor body are preferably identical. The electric machine according to the invention comprises, for example, one winding overhang guide per axial end of the rotor body. The winding overhang guide preferably comprises as many branches as there are teeth of the rotor body, each branch adjoining an axial end of one of these teeth. Preferably a single winding overhang guide comprises a branch housing the temperature sensor. The rotor preferably comprises one or more temperature sensors, each arranged in one or more branches of the winding overhang guide. Thus, two sensors on two different branches provide safety redundancy.

Advantageously, the branch comprises a portion that is entirely covered by the winding, the portion comprising a housing extending radially between the central part and the pole head and into which the temperature sensor is inserted. For example, the radial dimension of the housing represents at least 80% of the radial dimension of the winding.

Since the temperature of the wires of the winding is not the same over the radial dimension of the winding, this arrangement makes it possible for the temperature sensor to have a measurement representative of the temperature of the entire winding by extending into the entire housing. Specifically, the wires at the center of the winding are generally hotter than the peripheral wires of the winding.

Further advantageously, a thickness of the branch in the housing can place the temperature sensor in contact with the winding over the entire radial dimension of the housing. Thus, the temperature measurement is even more representative of the temperature of the winding. The thickness of the branch in the housing corresponds to the axial dimension of the branch between the rotor body and the temperature sensor. The housing therefore does not generally pass through the branch. By not being in direct contact with the rotor body, the temperature sensor is not biased by the heat given off by the rotor body, the winding overhang guide generally being made of insulating material.

In a variant embodiment, the housing is arranged in a head of the branch facing the winding. In this variant, the temperature sensor is preferably in contact with the entire axial thickness of the winding on the branch.

In one embodiment of the invention, the branch comprises a passage between the housing and a central space in the winding overhang guide, the passage being able to house connection wires for the temperature sensor. These connection wires make it possible to supply power to the temperature sensor. The temperature sensor is, for example, supplied with power by an electric power supply battery, which is arranged in the central space in the winding overhang guide.

Advantageously, the connection wires are connected to a power supply and management device for the temperature sensor, said device being arranged in the central space in the winding overhang guide. This arrangement enables easier access for maintaining this device. Preferably, the temperature sensor comprises means for wirelessly communicating with a control device of the rotor. The control device of the rotor is situated in a non-rotating part of the electric machine or of a vehicle incorporating this electric machine.

The invention also relates to an electric or hybrid vehicle comprising an electric machine according to the invention.

Other features and advantages of the invention will become further apparent from the following description, on the one hand, and from several exemplary embodiments, which are given by way of non-limiting indication with reference to the appended schematic drawings, on the other hand, in which:

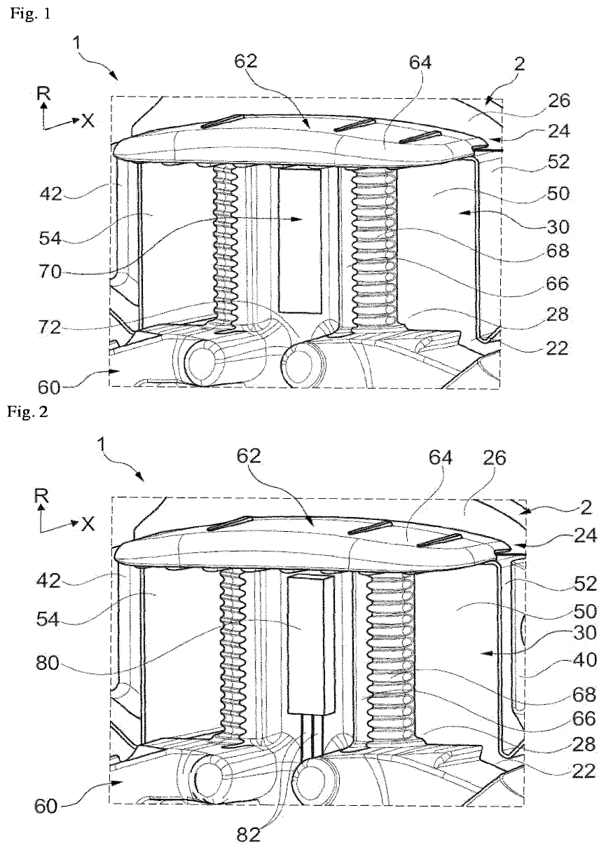

FIG. 1 partially shows an electric machine according to the invention, at a branch of a winding overhang guide, the branch comprising a housing for a temperature sensor, and

FIG. 2 also partially shows the electric machine in FIG. 1, in which the temperature sensor is arranged in the housing.

According to one embodiment of the invention, an electric machine according to the invention illustrated in FIG. 1 comprises a stator and a wound rotor 1 mounted on a rotating shaft (not shown).

The rotor 1 comprises a rotor body 2, made of magnetic steel, for example formed of a stack of laminations around the rotating shaft. The rotor body 2 comprises a central part 22 secured to the rotating shaft, on which teeth 24, formed integrally with the central part 22, are angularly distributed.

The rotating shaft is able to rotate about an axis parallel to an axial direction denoted X in FIG. 1. The axis of the rotating shaft also defines a radial direction, which is orthogonal to the axial direction and passes through the axis of the rotating shaft. Thus, in FIG. 1, the tooth 24 extends radially along a radial direction R, from the central part 22 of the rotor body 2 to a pole head 26. An angular direction is finally defined as being orthogonal to the axial and radial directions.

The tooth 24 extends, more specifically, axially from a first axial end of the rotor body 2 to a second axial end of the rotor body 2, and the tooth 24 extends radially from a base 28 of the tooth proximal to the central part 22 to the pole head 26 forming part of the tooth 24. The portion of the tooth 24 situated between the base 28 of the tooth and the pole head 26 is intended to accommodate one of the windings of the rotor (not shown). An electrical insulator 50, for example paper, surrounds this tooth portion over the entire radial and axial dimension of this portion of the tooth 24. The winding of the rotor is intended to fill in particular the space 30 situated between the electrical insulator 50 and another electrical insulator 52 situated between the tooth 24 and an adjacent tooth. This other insulator, which is for example made of paper, is folded into a V shape so as to accommodate a winding wedge 40 (shown in FIG. 2) with a triangular section, which holds the wires of the windings situated between the teeth of the rotor body in place despite the centrifugal force during operation of the electric machine. The winding of the rotor also fills, symmetrically with respect to a radial plane passing through the center of the tooth 24 and through the axis of the rotating shaft, a space situated between the electrical insulator 50 and yet another electrical insulator 54 situated between the tooth 24 and the other tooth that is adjacent thereto on the rotor body 2. Similarly, a winding wedge 42, with a triangular section, holds the wires of the windings situated between the tooth 24 and this other adjacent tooth in place.

The rotor body 2 comprises, in this embodiment of the invention, eight teeth, and is very similar to the rotor body shown in FIG. 6 of document FR3084220. In this document, each axial end of the rotor body is adjoined by a winding overhang guide with eight branches. In the embodiment of the invention described in this present application, the rotor body 2 is also adjoined by two winding overhang guides.

FIG. 1 shows the first axial end of the rotor body 2, which is adjoined by a winding overhang guide 60. On this first axial end of the rotor body 2, the winding overhang guide 60 comprises a central ring adjoining the central part 22 of the rotor body 2, and a plurality of branches extending radially on each axial end of the teeth of the rotor body 2. The winding overhang guide 60 is made of electrically insulating material, at least at the contact regions of the winding overhang guide with the windings of the rotor. For example, the winding overhang guide 60 is made of synthetic polymer (plastics) material.

The winding overhang guide 60 in particular comprises a branch 62 pressed against the axial end of the tooth 24 corresponding to the first axial end of the rotor body 2. More specifically, the branch 62 is pressed against the electrical insulator 50 at the part thereof situated on the axial end of the tooth 24.

The branch 62 comprises a branch head 64, which adjoins the pole head 26 of the tooth 24, and a portion 66 contained between the central ring of the winding overhang guide 60 and the branch head 64, this portion 66 being intended to be entirely covered by the wires of the winding of the rotor surrounding the tooth 24. The portion 66 comprises rounded flanks on which grooves 68, which are each arranged angularly, make it possible to each accommodate a wire of a first layer of the winding of the rotor, this first layer being proximal to the tooth 24. The grooves 68 on each flank of the portion 66 together entirely cover the radial dimension of this flank. In this way, the wires of the windings are guided when they are installed so as to entirely cover the portion 66 of the branch 62. The branch head 64 is intended to radially hold the wires of the winding passing angularly over this portion 66 of the branch 62, despite the centrifugal force. As a result, this branch head 64 forms an axial extension of the pole head 26, with a larger axial dimension than that of the portion 66 of the branch 62.

In this embodiment of the invention, the branch 62 comprises a housing 70 for a temperature sensor 80 (shown in FIG. 2) . This housing 70 is a through-housing, revealing the electrical insulator 50 in FIG. 1. In a variant embodiment of the invention, this housing is a blind housing.

The housing 70 in this case takes the form of a rectangular cavity contained between the rounded flanks of the portion 66 and extending radially over almost the entire radial dimension of this portion 66, for example 90% of this radial dimension. Since the temperature sensor 80 is, in this embodiment of the invention, an NTC or PTC thermistor, the material forming this thermistor encases the temperature sensor 80 and is therefore in contact with the wires of the winding of the rotor over the entire radial dimension of the housing 70, which it entirely occupies. Specifically, the depth, in the axial dimension, of the housing 70 is such that the temperature sensor 80 is in contact with the winding of the rotor when the tooth 24 is wound.

In a variant embodiment with a blind housing, the thickness of the branch 62 at the housing is such that the temperature sensor 80 is in contact with the winding of the rotor when the tooth 24 is wound. This thickness corresponds to the axial dimension of the portion 66 between a planar surface thereof, which is intended to be in contact with the electrical insulator 50 or the rotor body 2, and a surface for receiving the temperature sensor in the housing, parallel to this planar surface. The branch 62 also comprises a passage 72 between the housing 70 and a central space of the winding overhang guide 60, this passage 72 passing through the central ring of the winding overhang guide 60. This passage 72 makes it possible to bring the connection wires 82 for the temperature sensor 80 toward a central space of the winding overhang guide 60, in order to connect them to a power supply and management device for the temperature sensor 80.

This power supply and management device comprises a battery cell, for example. By virtue of this arrangement, it is not necessary to unwind the windings of the rotor in order to replace the battery cell.

The power Supply and management device for the temperature sensor 80, said device being situated in the central space in the winding overhang guide 60, also comprises an analog circuit and/or software enabling a value representative of the temperature of the rotor 1 to be transmitted to a control device of the rotor 1, which is situated in a non-rotating part of the electric machine or in a computer external to the electric machine. This representative value is, for example, a resistance value from the thermistor of the temperature sensor 80, the power supply and management device comprising an ohmmeter, or even directly a temperature value.

This value representative of the temperature of the rotor 1 is transmitted to the control device of the rotor 1 for example by wireless communication, using Bluetooth® or Zigbee® technology using IEEE standard 802.15.4.

Of course, the invention is not limited to the examples that have just been described and numerous modifications may be made to these examples without departing from the scope of the invention.

1-10. (canceled)

11. An electric machine comprising:
a stator;
a salient pole rotor;
a rotating shaft on which the rotor is mounted; and
a temperature sensor arranged between a winding of the rotor and a body of the rotor.

12. The electric machine as claimed in claim 11, wherein the temperature sensor comprises a thermistor.

13. The electric machine as claimed in claim 11, wherein the body of the rotor comprises a central part and a plurality of teeth distributed angularly around the central part, at least one tooth extending parallel to an axis of the rotating shaft from a first axial end of the body to a second axial end of the body, and extending radially from the central part to a pole head, the electric machine further comprising at least one winding overhang guide that is adjoined on the first or the second axial end of the body and comprising at least one branch arranged on an axial end of the tooth, the winding of the rotor surrounding the tooth and the branch of the winding overhang guide, the temperature sensor being housed in the branch of the winding overhang guide.

14. The electric machine as claimed in claim 13, wherein the branch comprises a portion that is entirely covered by the winding, the portion comprising a housing extending radially between the central part and the pole head and into which the temperature sensor is inserted.

15. The electric machine as claimed in claim 14, wherein a radial dimension of the housing represents at least 80% of a radial dimension of the winding.

16. The electric machine as claimed in claim 13, wherein a thickness of the branch in the housing is configured to place the temperature sensor in contact with the winding over an entire radial dimension of the housing.

17. The electric machine as claimed in claim 14, wherein the branch comprises a passage between the housing and a central space in the winding overhang guide, the passage being configured to house connection wires for the temperature sensor.

18. The electric machine as claimed in claim 17, wherein the connection wires are connected to a power supply and management device for the temperature sensor, said device being arranged in the central space in the winding overhang guide.

19. The electric machine as claimed in claim 11, wherein the temperature sensor comprises means for wirelessly communicating with a control device of the rotor.

20. An electric or hybrid vehicle comprising:
the electric machine as claimed in claim 11.
